(19) United States
(12) Patent Application Publication
(10) Pub. No.: US 2008/0210385 A1
(43) Pub. Date: Sep. 4, 2008

(54) RETRACTABLE SCREEN ASSEMBLY

(75) Inventors: Jeffrey V. Sawyers, Rice Lake, WI (US); Joseph D. Isaacs, Rice Lake, WI (US); Michael R. Jumbeck, Chippewa Falls, WI (US); Scott C. Sievers, Jordan, MN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: QUANEX CORPORATION, Houston, TX (US)

(21) Appl. No.: 12/039,560

(22) Filed: Feb. 28, 2008

Related U.S. Application Data
(60) Provisional application No. 60/903,926, filed on Feb. 28, 2007.

(51) Int. Cl. E06B 9/54; A47G 5/02

(52) U.S. Cl. 160/31; 160/313; 160/296; 160/270

(57) ABSTRACT

A retractable screen assembly includes a canister and a pair of tracks spaced from each other and extending in a direction transverse to the canister. A slide component is slideably engaged with the pair of tracks and is moveable toward and away from the canister along the tracks. The screen is coupled with the canister and with the slide component. The screen is selectively retractable to and dispensable from the canister as the slide component moves toward and away from the canister. A biasing device is coupled to the screen for urging the screen toward the canister to retract the screen to the canister as the slide component moves toward the canister. A shock absorber is disposed between the slide component and the canister for counteracting the biasing device to dampen relative movement between the slide component and the canister as the slide component moves toward the canister.

### CROSS-REFERENCE TO RELATED APPLICATIONS

The subject patent application claims priority to and all the benefits of U.S. Provisional Patent Application Ser. No. 60/903,926 which was filed on Feb. 28, 2007 the entire specification of which is expressly incorporated herein by reference.

### BACKGROUND OF THE INVENTION

1. Field of the Invention

The invention generally relates to a retractable screen assembly for disposition in a frame opening.

2. Description of the Related Art

Retractable screen assemblies are typically disposed in a frame opening of a building, such as a residential or commercial building. Generally, a window or a door is mounted in the frame opening along with the retractable screen assembly. Retractable screen assemblies generally include a screen retractably disposed within a canister. A slide component extends from the screen for selectively extending and retracting the screen across the frame opening, i.e., for covering and uncovering the frame opening with the screen. A spring-loaded spool is disposed in the canister and attached to an edge of the screen, opposite the slide component, for biasing the screen and to facilitate retracting of the screen back into the canister. As the spring-loaded spool retracts the screen into the canister, momentum and speed of the slide component may increase, causing the slide component to forcefully impact the canister. This phenomenon is commonly referred to as the guillotine effect in industry and is obviously undesirable. Also, a user may inadvertently slide the slide component at too high a velocity causing the slide component forcefully impact the canister. This impact may cause unwanted noise and can damage to various components of the screen assembly.

It would be advantageous to develop an improved retractable screen assembly that addresses the problems of the retractable screen assemblies of the prior art as set forth above.

### SUMMARY OF THE INVENTION AND ADVANTAGES

The present invention includes a retractable screen assembly comprising a canister. A pair of tracks are spaced from each other and extend in a direction transverse to the canister. A slide component extends between and is slideably engaged with the pair of tracks and is moveable toward and away from the canister along the pair of tracks. A screen has a first and a second end spaced from each other with the first end coupled with the canister and with the second end coupled to the slide component and with the screen selectively retractable to and dispensable from the canister as the slide component moves toward and away from the canister. A biasing device is coupled to the screen for urging the screen toward the canister to retract the screen to the canister as the slide component moves toward the canister. A shock absorber is disposed between the slide component and the canister for counteracting the biasing device to dampen relative movement between the slide component and the canister as the slide component moves toward the canister.

The shock absorber dampens the motion of the slide component as the screen retracts into the canister to offset the momentum and speed introduced by the spring-loaded spool and/or the user. Because the shock absorber dampens the motion, the slide component does not forcefully impact the canister as the screen is being retracted into the canister. Instead, upon operation of the shock absorber, the slide component moves toward the canister with reduced momentum and at a reduced velocity such that the slide component and/or the shock absorber gently contact the canister. The screen assembly is more aesthetically pleasing because the unwanted noise of the slide component forcefully impacting the canister has been eliminated. In addition, the durability of the entire screen assembly, including its various components, is increased by reducing the forcefulness of the impact between the slide component and the canister.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a retractable screen assembly disposed in an opening of a building;

FIG. 2 is a perspective view of a portion of the retractable screen assembly including a canister, a slide component, a screen extending from the canister to the slide component, and a shock absorber disposed on the slide component;

FIG. 3 is a front view of a portion of the retractable screen assembly with a slide component in an extended position such that the shock absorber is spaced from the canister;

FIG. 4 is a front view of a portion of the retractable screen assembly with the slide component in a retracted position such that the shock absorber contacts the canister;

FIG. 5 is a front view of a portion of the retractable screen assembly with the shock absorber disposed on the canister;

FIG. 6 is a partially exploded view of the canister;

FIG. 7A is a perspective view of the shock absorber;

FIG. 7B is an exploded view of the shock absorber;

FIG. 8 is a perspective view of a portion of the retractable screen assembly with a track of the retractable screen assembly being adjusted relative to a rail of the retractable screen assembly as the slide component is slid along the track;

FIG. 9 is a cross-sectional view of a portion of the retractable screen assembly along line 9-9 of FIG. 2;

FIG. 10 is a cross-sectional view of a portion of the retractable screen assembly along line 10-10 of FIG. 2; and

FIG. 11 is a perspective view of another embodiment of the retractable screen assembly.

### DETAILED DESCRIPTION OF THE INVENTION

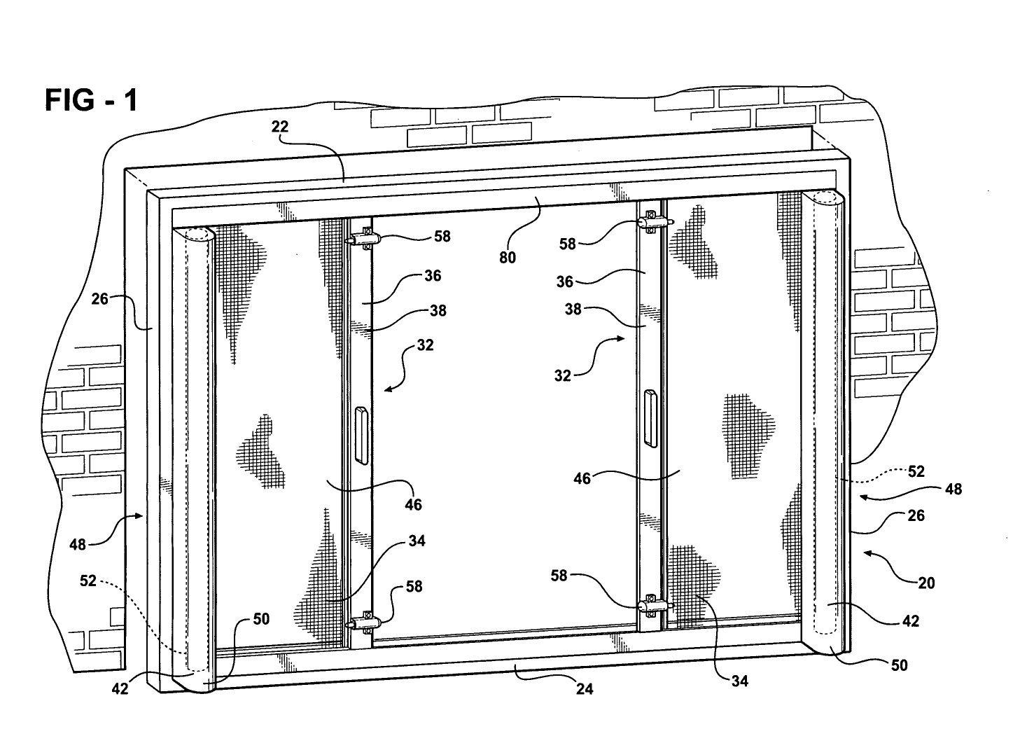

Referring to the Figures, wherein like numerals indicate corresponding parts throughout the several views, a retractable screen assembly 20 is generally shown and is referred to hereinafter as “screen assembly 20.” As shown in FIG. 1, the screen assembly 20 is typically installed in a building, such as a commercial or residential building. The building defines an opening, e.g., a door opening or a window opening, and the opening is framed by a header 22, a sill 24, and a pair of frame members 26. Specifically, the header 22 and the sill 24 are spaced from each other and extend generally horizontally and the frame members 26 are spaced from each other and extend generally vertically from the header 22 to the sill 24. The frame members 26 are also referred to in the art as jambs. The header 22, the sill 24, and the frame members 26 define a frame opening and the screen assembly 20 is disposed in the frame opening. The header 22, the sill 24, and the frame members 26 can be part of the screen assembly 20 or can be separate from the screen assembly 20. The header 22, the sill 24, and the frame members 26 are attached to the building and the screen assembly 20 is subsequently installed into the frame opening. Alternatively, a combination of the screen assembly 20 and the header 22, the sill 24, the frame members 26 are pre-assembled together to form a pre-assembled frame unit independent of the building for subsequent installation into the opening of the building. For example, the pre-assembled unit may be pre-assembled at a remote location and transported to the building for installation in the building.

As shown in FIGS. 1, 2, and 9, the screen assembly 20 includes a pair of rails 28 spaced from each other and a pair of tracks 30 with one tracks disposed along one of the rails and the other track 30 disposed along the other rail 28. As discussed further below, the screen assembly 20 includes at least one screen apparatus 32 slideably engaged with the tracks 30.

The first rail 28 typically extends horizontally and is mounted to the header 22. The second rail 28 typically extends horizontally and is mounted to the sill 24. The rails 28 are vertically spaced and fixed in position relative to each other. For example, the rails 28 are mounted to the header 22 and the sill 24, respectively, with threaded fasteners such as screws. It should be appreciated that the attachment and relative placement of the rails 28 to the building and the attachment of the tracks 30 to the respective rails 28 can be of any fashion without departing from the nature of the present invention.

The screen apparatus 32 includes a screen 34 and a slide component 36 coupled to the screen 34. The screen 34 is typically flexible and it is to be understood that screen 34 can be wire mesh style, silhouette style, and the like and can be manufactured from a wide array of materials including polymers and metals. The slide component 36 extends between and slideably interacts with the tracks 30 for selectively extending and retracting the screen 34 across the frame opening, as described further below. Specifically, the slide component 36 rigidly extends between the tracks 30 to function as a handle for moving the screen 34 across the frame opening, i.e., to cover and uncover the frame opening with the screen 34.

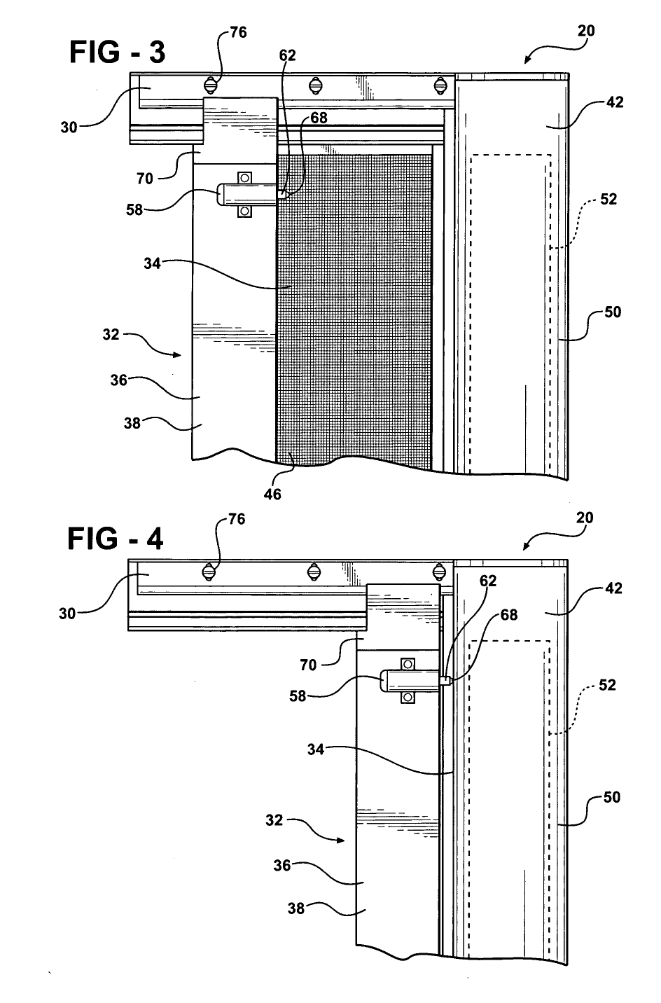

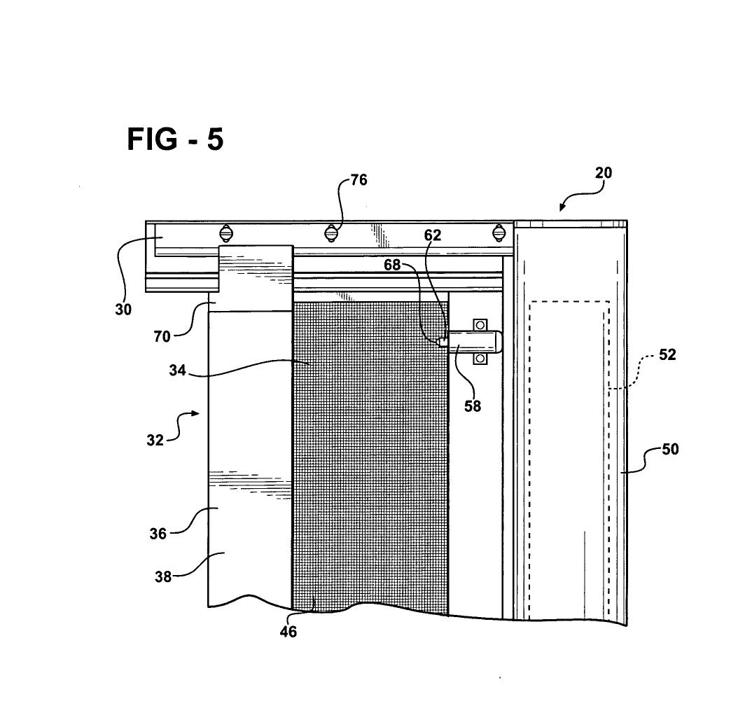

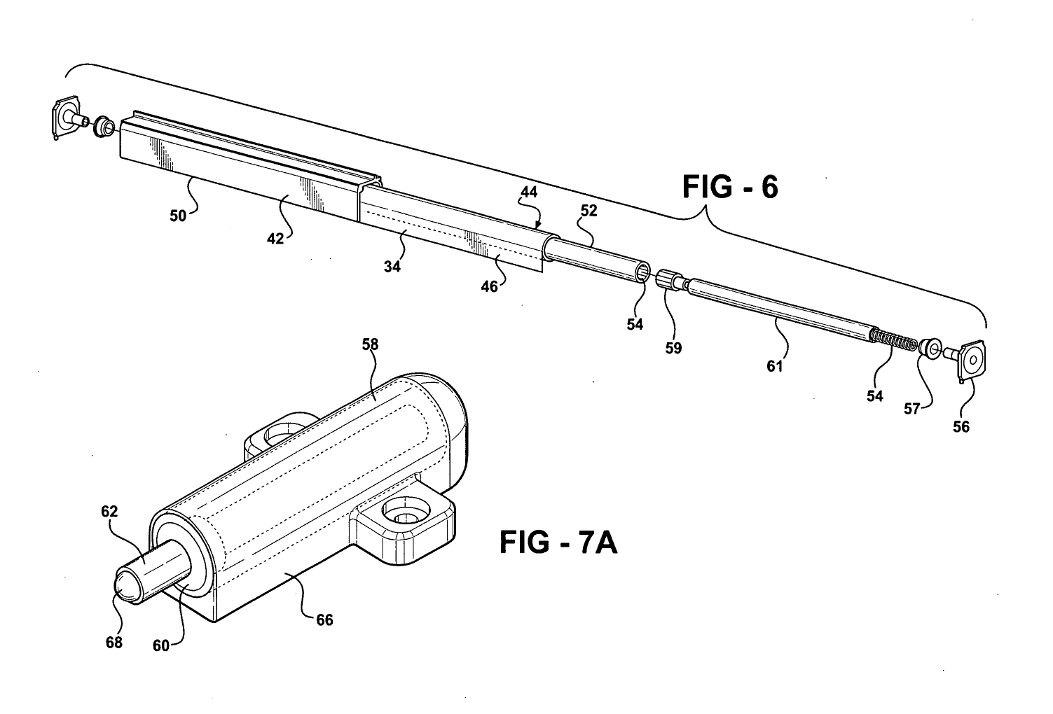

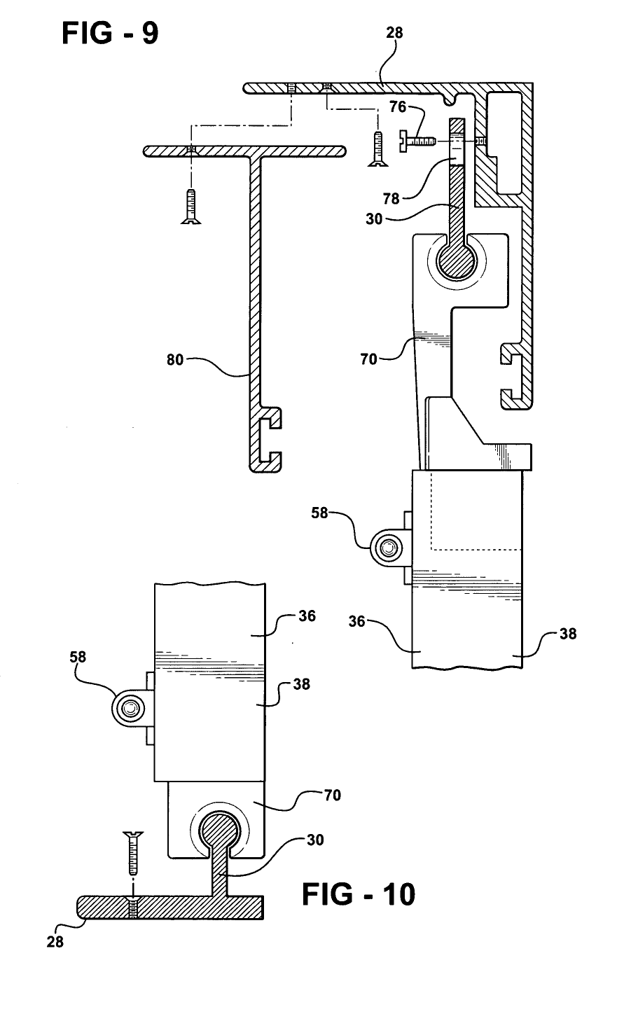

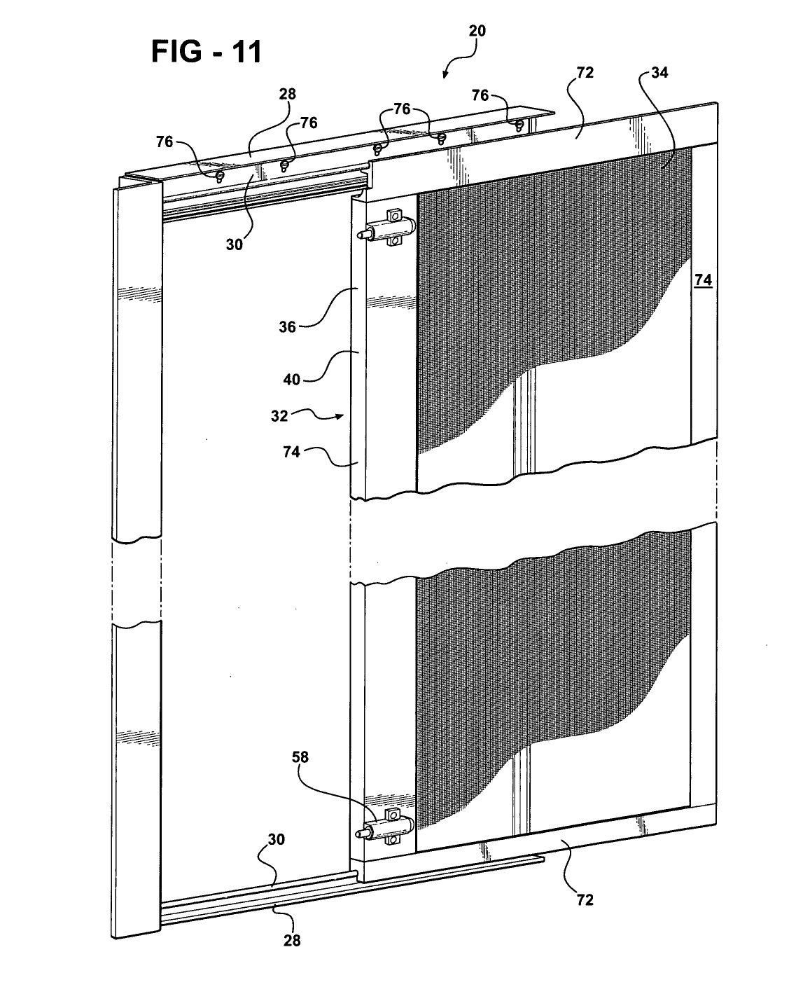

In one embodiment shown in FIGS. 1-8, the slide component 36 is of the type typically referred to in industry as slide bar 38 such that the screen assembly 20 is of the type typically referred to in industry as a retractable screen assembly. In another embodiment shown in FIG. 9, the slide component 36 is part of a screen frame 40 such that the screen assembly 20 is of the type typically referred to in industry as a sliding screen door assembly. Common features between the embodiments are labeled with common numbers in FIGS. 1-9. It should be appreciated that these two embodiments are exemplary and the screen apparatus 32 may be one of several other embodiments not particularly described herein without departing from the nature of the present invention.

With reference to the first embodiment shown in FIGS. 1-8, the screen assembly 20 includes a canister 42. Typically, the canister 42 is a component of the screen apparatus 32. The screen 34 has a first end 44 and a second end 46 spaced from the first end 44. The first end 44 is coupled with the canister 42 and the second end 46 is coupled with the slide bar 38. For example, the screen 34 may be splined into the slide bar 38.

As described further below, the canister 42 is spring-loaded such that the screen 34 is selectively retractable to and dispensable from the canister 42. The slide bar 38 is moveable along the tracks 30 and the screen 34 retracts to and dispenses from the canister 42 as the slide bar 38 moves toward the canister 42 and away from the canister 42.

The slide bar 38 guides the first end 44 of the screen 34 back and forth over the frame opening to cover and uncover the frame opening with the screen 34. Specifically, the screen 34 is dispensed from the canister 42 to cover the frame opening and is retracted into the canister 42 to uncover the opening. As described further below, the screen 34 is automatically retracted into the canister 42 as the slide bar 38 guides the first end 44 of the screen 34 toward the canister 42.

As shown in FIGS. 1-5, the canister 42 is disposed adjacent to and fixed relative to one of the frame members 26. The canister 42 may, for example, be mounted to one of the frame members 26. As described further below, the configuration shown in FIG. 1 includes two screen apparatuses 32 with one canister 42 mounted to one of the frame members 26 and another canister 42 mounted to the other frame member 26. The canister 42 and the frame member 26 in combination are referred to as a framing unit 48. It should be appreciated that the canister 42 and the frame member 26 of one framing unit 48 can be separately formed and subsequently assembled together or can be integral, i.e., formed together as a single unit.

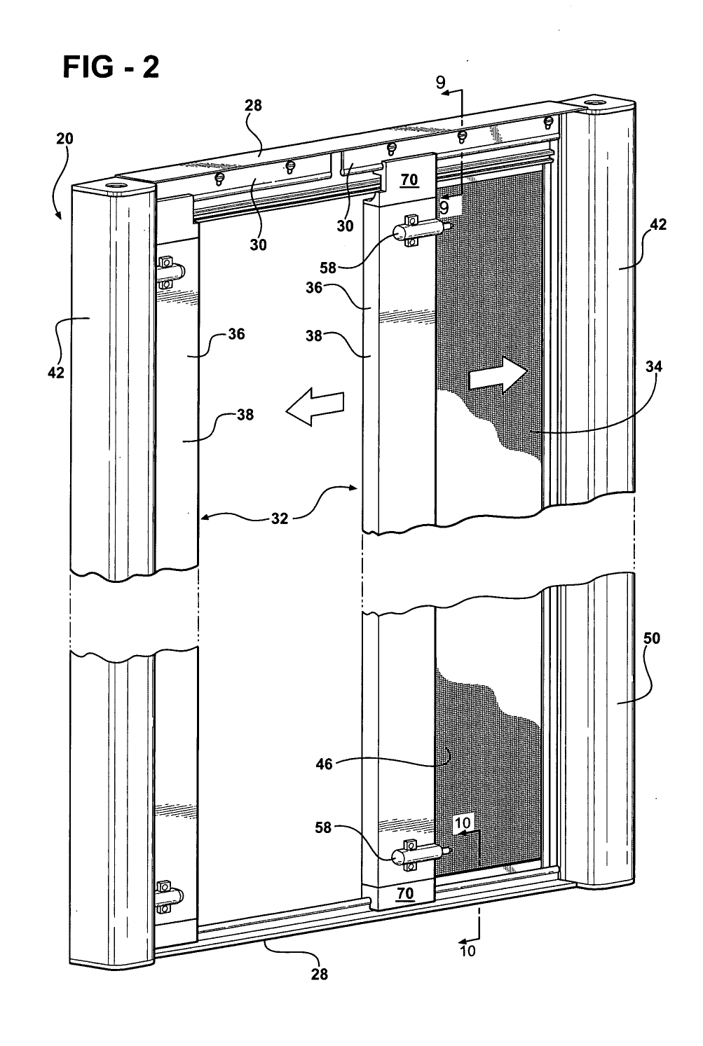

The rails 28 extend in a direction transverse to the framing unit 48. In the configurations shown in the Figures, the rails 28 extend in a direction transverse to both the canister 42 and the frame members 26. It should be appreciated that “transverse” is used herein to mean “crosswise” and the rails 28 can extend perpendicularly or angularly relative to the framing unit 48. It should also be appreciated that the rails 28 can extend in different directions relative to each other without departing from the nature of the present invention. In FIG. 2, the rails 28 contact and extend between each of the canisters 42. It should be appreciated that the rails 28 can be spaced from the canisters 42 and/or the frame members 26 without departing from the nature of the present invention.

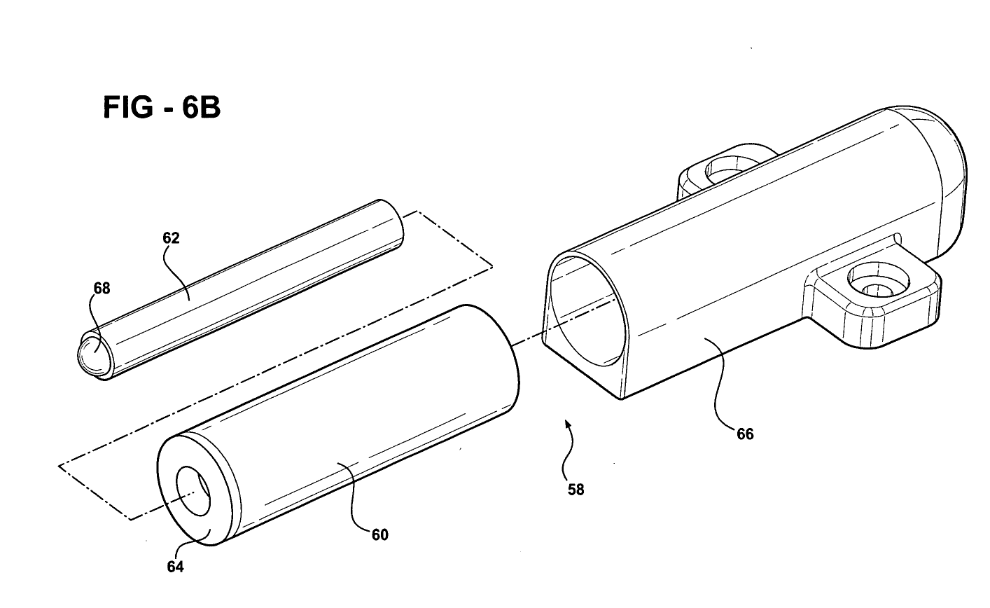

As shown in FIG. 6, the canister 42 includes a casing 50 and a spool 52 rotatable relative to the casing 50. The spool 52 is coupled to the first end 44 of the screen 34. It should be appreciated that the slide bar 38 is not shown in FIG. 6.

The screen assembly 20 includes a biasing device 54 coupled to the screen 34 for urging the screen 34 toward the canister 42 to retract the screen 34 to the canister 42 as the slide bar 38 moves toward the framing unit 48. The biasing device 54 is coupled to the spool 52 for rotationally loading the spool 52 as the screen 34 dispenses from the canister 43 and for rotating the spool 52 as the screen 34 retracts to the canister 42. In other words, the spool 52 tensions the screen 34 toward the canister 42 such that the second end 46 of the screen 34 is moved toward the canister 42 as the spool 52 rotates causing the screen 34 to automatically wrap around the spool 52. The tension in the screen 34 is between the first end 44 in the canister 42 and the second end 46 at the slide bar 38. The spool 52 constantly maintains the screen 34 in tension.

The spool 52 defines a cavity 54 that houses the biasing device 54. The canister 42 includes a spindle 56 fixed relative to the casing 50 and extending into the cavity 54. The spool 52 rotates relative to the spindle 56. The spool includes an insert 59 that engages the biasing device 54 and engages the spool 52. Specifically, an end of the biasing device 54 is fixed to the insert 59 and another end of the biasing device 54 is fixed to the spindle 56 such that the biasing device 54 is loaded as the insert 59 is rotated relative the spindle 56.

The insert 59 is splined and the spool 52 is splined in the cavity 54 such that the insert 59 is rotationally fixed to the spool 52, i.e., the insert 59 does not rotate relative to the spool 52, and such that the insert 59 is slideable axially along the cavity 54 of the spool 52. As the screen 34 is extended from the canister 42, the spool 52 rotates thereby rotating the insert 59 relative to the spindle 56 to load the biasing device 54. As the screen 34 is retracted toward the canister 42, the biasing device 54 rotates the spool 52 to wrap the screen 34 about the spool 52.

The biasing device 54 can, for example, be a torsion spring or a coil spring. However, it should be appreciated that the biasing device 54 can be any type of biasing device 54 that urges the screen 34 toward the canister 42 to retract the screen 34 to the canister 42 without departing from the nature of the present invention.

A sheath 61 can extend between the insert 59 and the spindle 56 to house the biasing device 54 in the cavity 54. A bushing 57 can be rotatably coupled to the spindle 56 and fixed to the sheath 61. The canister can include a second spindle (not numbered) and a second bushing (not numbered) coupled to the spool 52 on an end of the spool 52 opposite the spindle 56 and the bushing 57. In such a configuration, for example, the second bushing is fixed relative to the spool 52 and rotatably engaged with the spindle 56.

It should be appreciated that the configuration of the canister 42 including the spindle 56, cavity 54, etc., is exemplary and the canister 42 can have any configuration such that the biasing device 54 urges the screen 34 toward said canister 42 to retract the screen 34 to said canister 42 as said slide bar 38 moves toward said canister 42 without departing from the nature of the present invention. It should also be appreciated that the canister 42 can include a mechanism to regulate the rotational speed of the spool 52.

The screen assembly 20 includes at least one shock absorber 58 disposed between the slide bar 38 and the framing unit 48. The shock absorber 58 dampens, i.e., cushions, the movement of the slide bar 38 as the screen 34 is retracted into the canister 42. In other words, the shock absorber 58 reduces the momentum of the slide bar 38 as the slide bar 38 approaches the framing unit 48 to prevent the slide bar 38 from forcefully impacting the framing unit 48.

The shock absorber 58 counteracts the biasing device 54 to dampen relative movement between the slide bar 38 and the framing unit 48 as the slide bar 38 moves toward the framing unit 48 and the shock absorber 58 contacts the framing unit 48. As described above, the biasing device 54 constantly maintains the screen 34 in tension and exerts force on the slide bar 38 to pull the slide bar 38 toward the framing unit 48 as a user slides the slide bar 38 toward the framing unit 48. The shock absorber 58 acts against the biasing device 54 to reduce the momentum and speed of the slide bar 38 as it approaches the framing unit 48 to prevent a forceful impact between the slide bar 38 and the framing unit 48.

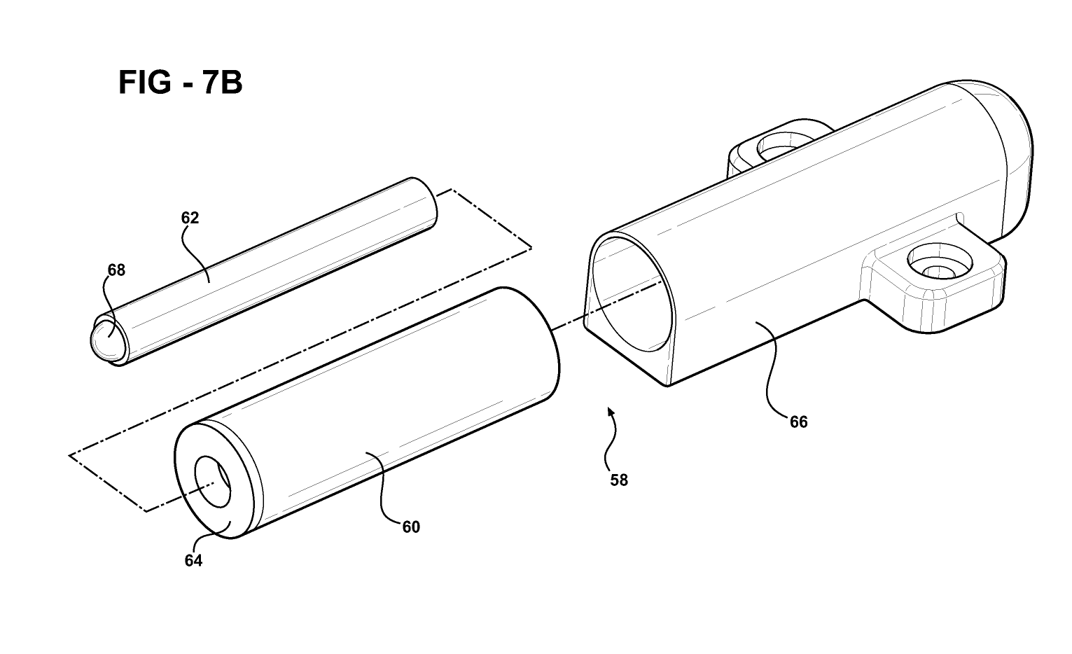

The shock absorber 58 can include a cylinder 60 and a plunger 62 slideably engaged with and extending from the cylinder 60. Specifically, the cylinder 60 defines a bore 64 slideably receiving the plunger 62. In the embodiment of the shock absorber 58 shown in FIGS. 7A-7B, the plunger 62 is rod shaped with a bumper extending from the plunger 62. The bumper is formed from rubber, plastic, or any other type of material for cushioning impact. As the slide bar 38 is moved toward the framing unit 48, the bumper of the plunger 62 contacts the framing unit 48 to cushion the impact.

The shock absorber 58 can include a plunger biasing device (not numbered) for urging the plunger 62 to be extended from the cylinder 60. As shown in FIGS. 1-3, when plunger 62 extends from the cylinder 60 when the plunger 62 is not compressed between the slide bar 38 and the framing unit 48. When the shock absorber 58 is compressed between the slide bar 38 and the framing unit 48, the plunger 62 is pushed into the bore 64 against the urging of the plunger biasing device to absorb energy and slow the movement of the slide bar 38.

For example, the plunger biasing device can include a coil spring and/or mechanisms for controlling fluids, e.g., for hydraulic or pneumatic shock absorption. In the configuration shown in FIGS. 6A-6B, the cylinder 60 houses hydraulic fluid and acts as the plunger biasing device, i.e., the shock absorber is a hydraulic shock absorber. However, it should be appreciated that the embodiment of the shock absorber 58 shown in FIGS. 6A-6B is exemplary and the shock absorber 58 can be one of several other embodiments without departing from the nature of the present invention. For example, the shock absorber 58 can have any configuration and can include springs, hydraulic mechanisms, pneumatic mechanisms, elastically compressible materials, etc., such that the shock absorber 58 dampens the movement of the slide bar 38 as the screen is retracted into the canister 42.

The shock absorber 58 is mounted to the one of the framing unit 48 and the slide bar 38 and extends toward the other of the framing unit 48 and the slide bar 38. As shown in FIGS. 1-3, the shock absorber 58 is mounted to the slide bar 38 and is moveable with the slide bar 38 toward and away from the canister 42. On the other hand, as shown in FIG. 4, the shock absorber 58 is mounted to the canister 42. It should be appreciated that the shock absorber 58 can be mounted to any other structure, e.g., the frame member 26, the header 22, or the sill 24 without departing from the nature of the present invention.

As shown in FIGS. 6A-6B, the shock absorber 58 includes a housing 66 and the cylinder 60 is mounted to the housing 66. As shown in FIGS. 1-4, the housing 66 couples the cylinder 60 to the slide bar 38 such that the cylinder 60 is fixed relative to the slide bar 38 and moveable with the slide bar 38 toward and away from the framing unit 48.

As described above, the slide bar 38 is moveable relative to the framing unit 48, and specifically the slide bar 38 is moveable between an extended and a retracted position. The shock absorber 58 is spaced from the other of the framing unit 48 and the slide bar 38 when the slide bar 38 is in the extended position and the shock absorber 58 is in contact with the other of the framing unit 48 and the slide bar 38 in the retracted position. Specifically, the plunger 62 extends from the cylinder 60 to a free end 68. When the shock absorber 58 is mounted on the slide bar 38, the free end 68 is spaced from the framing unit 48 when the slide bar 38 is in the extended position and the free end 68 in contact with the framing unit 48 in the retracted position. Therefore, the shock absorber 58 does not dampen the motion of the slide bar 38 along the entire length of the rail 28 but rather dampens the motion of the slide bar 38 only as the slide bar 38 nears the framing unit 48. As such, the slide bar 38 can be quickly slid along the tracks 30 toward the retracted position and the velocity of the slide bar 38 is not slowed by the shock absorber 58 until the slide bar 38 nears the framing unit 48 thereby allowing for quick entry and egress of users through the frame opening.

The slide bar 38 can include additional elements commonly referred to in the art as glides or glide blocks 70 at an interface between the slide bar 38 and the tracks 30 to engage and slide along the respective track 30. The glide blocks 70 can be moveable relative to the rest of the slide bar 38 as the slide bar 38 slides along the tracks 30 to provide a smooth motion of the slide bar 38 along the tracks 30. One example of such glide blocks 70 is disclosed in U.S. Patent Application Publication No. 2007/0029049 to Martineau et al., the entire specification of which is expressly incorporated herein by reference.

In the embodiment shown in FIG. 9, the screen frame 40 is rigid to support the screen 34. The screen frame 40 typically includes a pair of horizontal members 72 spaced from each other and a pair of vertical members 74 spaced from each other and extending between the horizontal members 72 to define a rectangular opening. The screen 34 is attached to the vertical 74 and horizontal 76 members and extends across the rectangular opening. For example, the screen 34 may be splined to the vertical 74 and horizontal 76 members. The pair of horizontal members 76 and/or the pair of vertical members 74 may slideably interact with the tracks 30. The screen frame 40 is slid along the tracks 30 to cover and uncover the frame opening with the screen 34.

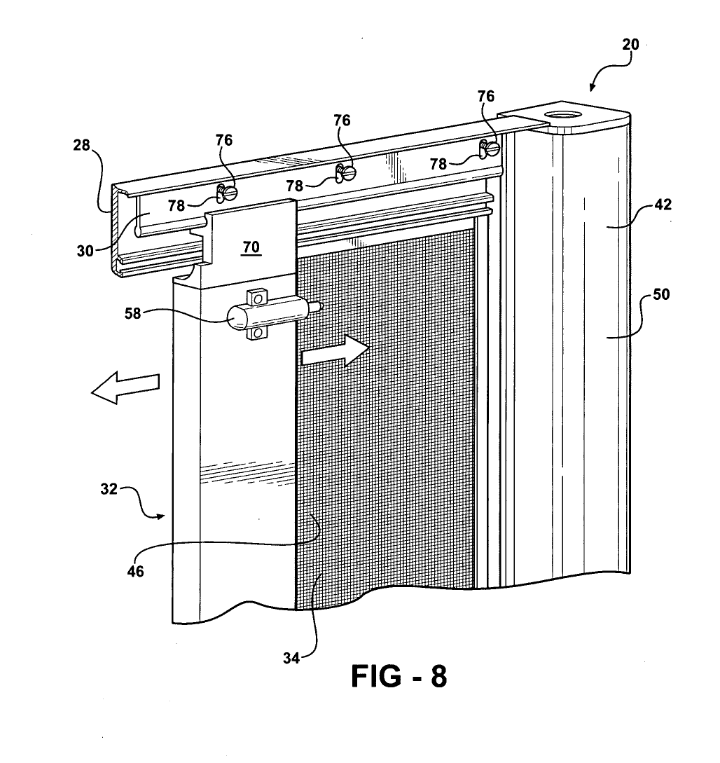

The track 30 can be adjustably coupled to the rail 28 for selectively positioning the track 30 relative to the rail 28. Specifically, a location of one of the tracks 30 relative to the respective rail 28 may be adjusted to align the tracks 30 to be parallel with each other to reduce racking of the slide bar 38 as the slide bar 38 is slid along the tracks 30, i.e., creating an even rod and bearing fit as referred to in industry. As shown in FIGS. 7-9, to facilitate alignment between the tracks 30, the screen assembly 20 includes a fastener 76 extending from one of the tracks 30 and the rail 28 defines an aperture 78 sized larger than the fastener 76. The respective rail 28 receives the fastener 76 in the aperture 78. Because the aperture 78 is sized larger than the fastener 76, the fastener 76 moves along the aperture 78 to allow the track 30 to move relative to the rail 28. As shown in FIG. 8, the tracks 30 are aligned with each other by sliding the slide bar 38 along the tracks 30 when the fastener 76 is loosened relative to the respective track 30. When the slide bar 38 is slid along the tracks 30, the slide bar 38 exerts force on the tracks 30 such that the tracks 30 become parallel, at which time the fasteners 76 are tightened to prevent movement of the track 30 relative to the rail 28. An example of such a configuration is disclosed in U.S. Patent Application Publication No. 2007/0199667 to Jumbeck et al., the entire specification of which is incorporated herein by reference.

As shown in FIGS. 1 and 8, the screen assembly 20 can include a cover 80 extending along the one of the rails 28, e.g., the top rail, with the track 30 positioned between the cover 80 and the rail 28. The cover is removably coupled to the rail 28 for allowing access to the track 30. It should be appreciated that the cover 80 is not shown in FIG. 2-4 or 9.

As shown in FIGS. 1 and 2, the screen assembly 20 can include a pair of screen apparatuses 32, e.g., a pair of canisters 42, a pair of slide bars 38, and a pair of screens 34. In such a configuration, the screen apparatuses 32 mirror each other and the slide bars 38 can slide toward one another and meet to cover the frame opening. In such a case, the pair of slide bars 38 typically includes complimentary engaging features such that the slide bars 38 engage each other when contacted to each other.

In the Figures, the screen assembly 20 is oriented such that the screen 34 moves horizontally across the frame opening to cover and uncover the frame opening. However, it should be appreciated that the screen assembly 20 can be oriented such that the screen 34 moves vertically across the frame opening to cover and uncover the frame opening without departing from the nature of the present invention.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A retractable screen assembly comprising:
a canister;
a pair of tracks spaced from each other and extending in a direction transverse to said canister;
a slide component extending between and slideably engaged with said pair of tracks and moveable toward and away from said canister along said pair of tracks;
a screen having a first and a second end spaced from each other with said first end coupled with said canister and with said second end coupled to said slide component and with said screen selectively retractable to and dispensable from said canister as said slide component moves toward and away from said canister;
a biasing device coupled to said screen for urging said screen toward said canister to retract said screen to said canister as said slide component moves toward said canister; and
a shock absorber disposed between said slide component and said canister for counteracting said biasing device to dampen relative movement between said slide component and said canister as said slide component moves toward said canister.

2. The retractable screen assembly as set forth in claim 1 wherein said shock absorber is mounted to and extends from one of said canister and said slide component toward the other of said canister and said slide component.

3. The retractable screen assembly as set forth in claim 2 wherein said shock absorber is mounted to said slide component and is moveable with said slide component toward and away from said canister.

4. The retractable screen assembly as set forth in claim 2 wherein said slide component is moveable toward said canister to a retracted position and away from said canister to an extended position and wherein said shock absorber is spaced from the other of said canister and said slide component when said slide component is in said extended position and said shock absorber is in contact with the other of said canister and said slide component in said retracted position.

5. The retractable screen assembly as set forth in claim 2 wherein said shock absorber includes a cylinder fixed relative to said one of said canister and said slide component and a plunger slideably engaged with and extending from said cylinder toward said other of said canister and said slide component.

6. The retractable screen assembly as set forth in claim 5 wherein said slide component is moveable toward said canister to a retracted position and away from said canister to an extended position and wherein said plunger extends from said cylinder to a free end with said free end spaced from said other of said canister and said slide component when said slide component is in said extended position and with said free end in contact with said other of said canister and said slide component in said retracted position.

7. The retractable screen assembly as set forth in claim 6 wherein said cylinder is mounted to said slide component and is moveable with said slide component toward and away from said canister.

8. The retractable screen assembly as set forth in claim 5 wherein said cylinder defines a bore receiving said plunger and wherein said shock absorber includes a plunger biasing device for urging said plunger along said bore toward said other of said canister and said slide component.

9. The retractable screen assembly as set forth in claim 1 wherein said canister includes a casing and a spool rotatably supported within said casing with said spool coupled to said first end of said screen and with said biasing device coupled to said spool for rotating said spool as said screen retracts to and dispenses from said canister.

10. The retractable screen assembly as set forth in claim 9 wherein said biasing device is rotationally fixed relative to said casing and rotationally fixed relative to said spool.

11. The retractable screen assembly as set forth in claim 10 wherein said canister includes a spindle fixed relative to said casing with said biasing device rotationally fixed to said spindle.

12. The retractable screen assembly as set forth in claim 11 wherein spool defines a cavity that houses said biasing device with said biasing device fixed to said spool in said cavity and with said spindle extending into said cavity.

13. The retractable screen assembly as set firth in claim 9 wherein said biasing device is a torsion spring.

14. The retractable screen assembly as set forth in claim 1 further including a first pair of frame members spaced from each other and a second pair of frame members spaced from each other and extending transverse to said first pair of frame members.

15. The retractable screen assembly as set forth in claim 13 wherein said canister is disposed adjacent to and fixed relative to one of said first pair of frame members and said first track is disposed along one of said second pair of frame members and said second track is disposed along said the other of said second pair of frame members.

16. A retractable screen assembly comprising:
a framing unit having a frame member and a canister disposed adjacent to and fixed relative to said frame member;
a pair of rails spaced from each other and extending in a direction transverse to said framing unit;
a pair of tracks with one of said tracks disposed along one of said rails and with the other of said tracks disposed along the other of said rails;
a slide component extending between and slideably engaged with said pair of tracks and moveable toward and away from said framing unit along said pair of tracks;
a screen having a first and a second end spaced from each other with said first end coupled with said canister and with said second end coupled to said slide component and with said screen selectively retractable to and dispensable from said canister as said slide component moves toward and away from said framing unit;
a biasing device coupled to said screen for urging said screen toward said canister to retract said screen to said canister as said slide component moves toward said framing unit; and
a shock absorber disposed between said slide component and said framing unit for counteracting said biasing device to dampen relative movement between said slide component and said framing unit as said slide component moves toward said framing unit.

17. The retractable screen assembly as set forth in claim 16 wherein said shock absorber is mounted to and extends from one of said framing unit and said slide component toward the other of said unit and said slide component.

18. The retractable screen assembly as set forth in claim 17 wherein said shock absorber is mounted to said slide component and is moveable with said slide component toward and away from said canister.

19. The retractable screen assembly as set forth in claim 17 wherein said slide component is moveable toward said framing unit to a retracted position and away from said framing unit to an extended position and wherein said shock absorber is spaced from the other of said framing unit and said slide component when said slide component is in said extended position and said shock absorber is in contact with said other of said framing unit and said slide component in said retracted position.

20. The retractable screen assembly as set forth in claim 17 wherein said shock absorber includes a cylinder fixed relative to said one of said framing unit and said slide component and a plunger slideably engaged with and extending from said cylinder toward said other of said framing unit and said slide component.

21. The retractable screen assembly as set forth in claim 20 wherein said slide component is moveable toward said framing unit to a retracted position and away from said framing unit to an extended position and wherein said plunger extends from said cylinder to a free end with said free end spaced from said other of said framing unit and said slide component when said slide component is in said extended position and with said free end in contact with said other of said framing unit and said slide component in said retracted position.

22. The retractable screen assembly as set forth in claim 21 wherein said cylinder is mounted to said slide component and is moveable with said slide component toward and away from said framing unit.

23. The retractable screen assembly as set forth in claim 20 wherein said cylinder defines a bore receiving said plunger and wherein said shock absorber includes a plunger biasing device for urging said plunger along said bore toward said other of said canister and said slide component.

24. The retractable screen assembly as set forth in claim 23 wherein said shock absorber includes a biasing device disposed in said bore for urging said plunger toward said other of said framing unit and said slide component.

25. The retractable screen assembly as set forth in claim 1 wherein said canister includes a casing and a spool rotatably supported within said casing with said spool coupled to said first end of said screen and with said biasing device coupled to said spool for rotating said spool as said screen retracts to and dispenses from said canister.

26. The retractable screen assembly as set forth in claim 16 wherein said biasing device is rotationally fixed relative to said casing and rotationally fixed relative to said spool.

27. The retractable screen assembly as set forth in claim 26 wherein said canister includes a spindle fixed relative to said casing with said biasing device rotationally fixed to said spindle.

28. The retractable screen assembly as set forth in claim 27 wherein spool defines a cavity that houses said biasing device with said biasing device fixed to said spool in said cavity and with said spindle extending into said cavity.

29. The retractable screen assembly as set fifth in claim 26 wherein said biasing device is a torsion spring.
